(19) United States
(12) Patent Application Publication
(10) Pub. No.: US 2024/0160509 A1
(43) Pub. Date: May 16, 2024

(54) RISK ENTITY CONFIGURATIONS FOR RESOURCE MONITORING

(71) Applicant: VMWARE, INC., Palo Alto, CA (US)

(72) Inventors: Naren LAL, Bangalore (IN); Akshay ANAND, Bangalore (IN); Saritha H, Bangalore (IN); Vaishali KHURANA, Bangalore (IN); Sree Charan KOWALI, Bangalore (IN)

(21) Appl. No.: 17/986,929

(22) Filed: Nov. 15, 2022

(51) Int. Cl. G06F 11/00; G06F 9/50

(52) U.S. Cl. CPC G06F 11/004; G06F 9/5077; G06F 2201/815; G06F 2209/505; G06F 2209/508

(57) ABSTRACT

In an example, a management node may include a processor and a memory coupled to the processor. Further, the memory includes a message bus and a risk assessment unit. During operation, the risk assessment unit may configure a risk entity. The risk entity may include a risk type and a risk level corresponding to the risk type. Further, the risk assessment unit may associate the risk entity to a resource deployed in a cloud computing platform. Furthermore, the risk assessment unit may monitor the resource to assess a risk value associated with the resource based on the risk type and the risk level and generate a risk assessment report corresponding to the monitored resource. Further, the risk assessment unit may publish the risk assessment report on the message bus. The message bus may send the risk assessment report to a subscribed consumer service.

### TECHNICAL FIELD

The present disclosure relates to computing environments, and more particularly to methods, techniques, and systems for monitoring resources in the computing environments based on configured risk entities.

### BACKGROUND

Data centers execute numerous applications that enable businesses, governments, and other organizations to offer services over the Internet. An example data center can be a hyper-converged infrastructure (HCI) solution. The HCI is a type of virtual computing platform that converges compute, networking, virtualization, and storage into a single software-defined architecture. For instance, a single software application can interact with each component of hardware and software as well as an underlying operating system. Hyper-converged infrastructures provide enterprises and other organizations with modular and expandable compute, storage, and network resources as well as system backup and recovery. In the hyper-converged infrastructure, compute, storage, and network resources are brought together using preconfigured and integrated hardware. In hyper-converged infrastructures, multiple physical hosts can be clustered together to create clusters and/or workload domains of shared compute and storage resources. Further, physical hosts in a host pool may be provisioned to the clusters based on a user request or resource utilization of the clusters, for instance. In such hyper-converged infrastructures, a centralized control may be provided to the components (e.g., the compute, networking, virtualization, and storage components) to perform different data center operations such as a data center security operation, a data center expansion operation, a data center deletion operation, a data center shrink operation, a data center update/upgrade operation, and the like.

### BRIEF DESCRIPTION OF THE DRAWINGS

FIG. 1A is a block diagram of an example computing environment, depicting a management node to monitor a resource in a computing environment based on a configured risk entity;

FIG. 1B is a block diagram of the example computing environment of FIG. 1A, depicting additional features;

FIG. 2 is a flow diagram illustrating an example computer-implemented method for generating a risk assessment report corresponding to a resource in a computing environment based on a configured risk entity;

FIG. 3A is an example graphical user interface depicting creation of a risk entity;

FIG. 3B is another example graphical user interface depicting creation of another risk entity;

FIG. 3C is an example graphical user interface depicting attaching the risk entity of FIG. 3A to a resource;

FIG. 3D is another example graphical user interface depicting attaching the risk entity of FIGS. 3A and 3B to a resource;

FIG. 3E is an example graphical user interface depicting a risk assessment report;

FIG. 4 is an example graphical user interface depicting associating a risk type to an operation associated with a resource; and

FIG. 5 is a block diagram of an example management node including non-transitory computer-readable storage medium storing instructions to prevent an operation from being performed corresponding to a resource in a computing environment based on a configured risk entity.

The drawings described herein are for illustrative purposes and are not intended to limit the scope of the present subject matter in any way.

### DETAILED DESCRIPTION

Examples described herein may provide an enhanced computer-based and/or network-based method, technique, and system to monitor a resource in a computing environment based on a configured risk entity. The paragraphs and present an overview of the computing environment, existing methods to monitor resources in the computing environment, and drawbacks associated with the existing methods.

Computing environment may be a physical computing environment (e.g., an on-premises enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

The data center can be an on-premises data center, a cloud data center, or a hybrid data center. For example, the data center can be a software-defined data center (SDDC) having a hyper-converged infrastructure solution. The term “hyper-converged infrastructure” may refer to a type of virtual computing platform that converges compute, networking, virtualization, and storage into a single software-defined architecture. The hyperconverged infrastructure may include virtualized computing (e.g., a hypervisor), a virtual storage area network (vSAN) (e.g., software-defined storage), and virtualized networking (e.g., software-defined networking). For example, Vmware® cloud foundation (VCF) is a hybrid cloud platform for managing virtual machines and orchestrating containers, built on a full stack hyperconverged infrastructure technology.

Such hyperconverged infrastructures introduces the use of workload domains in hybrid clouds. Workload domains are physically isolated containers that hold (e.g., execute) a group of applications with a substantially similar performance requirement, availability requirement, and/or security requirement executing on one or more compute nodes (e.g., servers). The workload domains may include different combinations of servers (i.e., physical hosts) and network equipment which can be set up with varying levels of hardware redundancy and varying quality of components. A workload domain may represent a logical unit that groups physical hosts (e.g., enterprise-class, type-1 hypervisor (ESXi) servers) managed by a server instance (e.g., vCenter server) with specific characteristics according to software defined data center (SDDC) polices. Thus, the workload domain may include multiple clusters of physical hosts.

The cluster may be a collection of resources (e.g., physical hosts) that collectively provide scalable services to end users and to their applications while maintaining a consistent, uniform, and single system view of the cluster services. Each node may be a single entity machine or server having compute, storage, and/or network capacity. Example cluster may be a stretched cluster, a multi-availability zone (AZ) cluster, a metro cluster, or a high availability (HA) cluster that crosses multiple areas within a local area network (LAN), a wide area network (WAN), or the like. By design, the cluster may provide a single point of control for cluster administrators and at the same time, the cluster may facilitate addition, removal, or replacement of individual resources without significantly affecting the services provided by the hyperconverged infrastructure.

Such cloud platforms may offer centralized control for deployed components (e.g., vCenter server (i.e., a centralized management utility to manage virtual machines), vSAN (a storage virtualization application to provide software defined storage solution), NSX-T (e.g., a unified networking platform to build cloud-native application environments), ESXI servers, and the like in the hyperconverged infrastructure. For example, upon establishing or deploying the data center, data center operations may be carried over on the established data center. The centralized control is for performing the data center operations. Example data center operations may include data center security operations and data center on-demand operations. The data center security operations may be performed for securing the data center operations like password management, certificate management, and the like. Further, the data center on-demand operations may include data center workload or cluster creation, deletion, updating (e.g., expand, shrink, or the like), and the like based on customer demands.

Such computing environments may include multiple workflows that automate various user operations at the workload domain level. However, such user operations may fail due to various reasons such as component misconfigurations, system health, lock management (e.g., used to avoid having simultaneous tasks performed on the same target datastores or virtual machines), and the like. Such failures may lead to a system going into an inconsistent state, which can further lead to the system going into inaccessible state. Computing environments, such as VCF, may orchestrate various management components and hence workflow failures can cause severe impact on the customer environment.

Examples described herein may provide a management node to configure a risk entity for a resource in a computing environment and monitor the resource based on the configured risk entity to avoid the resource going into an inaccessible state. In an example, the management node may configure a risk entity. The risk entity may include a risk type corresponding to an operation and a risk level corresponding to the risk type. Further, the management node may associate the risk entity to a resource (e.g., a workload domain, a physical host computing system, a virtual machine, a container, or the like) deployed in a cloud computing platform. Furthermore, the management node may monitor the resource to assess a risk value associated with the resource based on the risk type and the risk level. Further, the management node may generate a risk assessment report corresponding to the monitored resource and publish the risk assessment report on a message bus. The message bus may then send the risk assessment report to a subscribed consumer service. In other examples, the management node may prevent the operation from being performed corresponding to the resource based on the risk value. Thus, examples described herein provides an approach to configure the risk entity based on user's experience to facilitate in monitoring the resource according to the configured risk entity to avoid failure of the resource.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

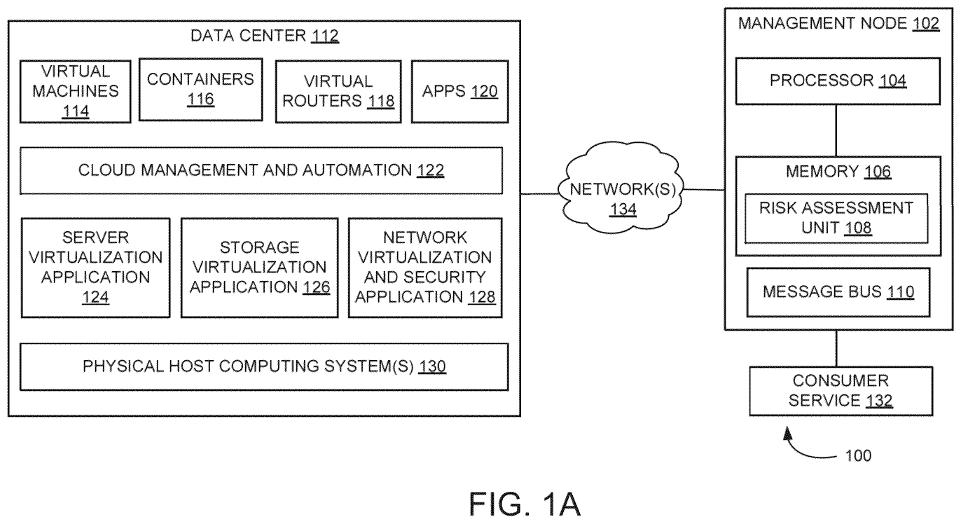

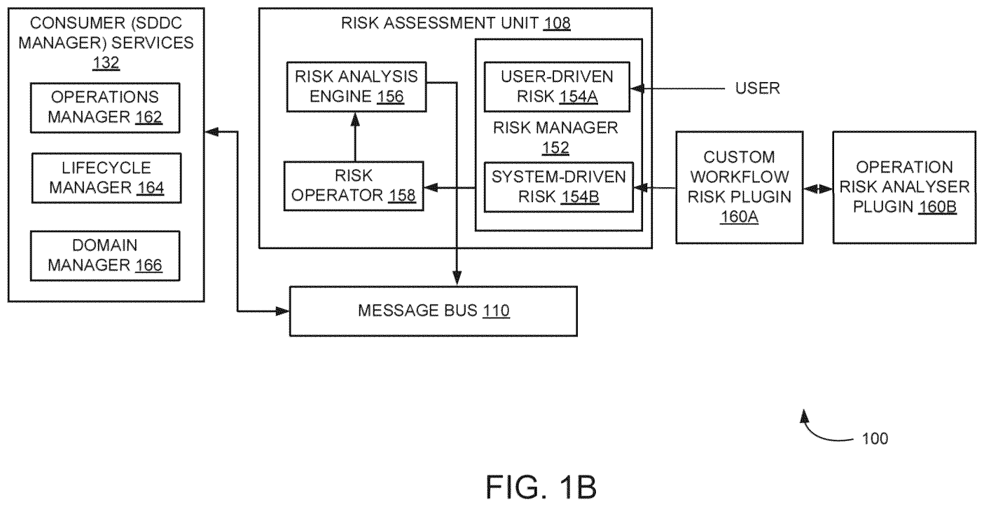

FIG. 1A is a block diagram of an example computing environment 100, depicting a management node 102 to monitor a resource in a data center 112 based on a configured risk entity. Computing environment 100 may be based on the deployment of physical resources across a network, virtualizing the physical resources into virtual resources, and provisioning the virtual resources in data center 112 for use across cloud computing services and applications. Data center 112 may refer to a centralized physical facility where servers, network, storage, and other information technology equipment that support business operations exist. Further, components in data center 112 include or facilitate business-critical applications, services, data, and the like.

For example, data center 112 may be a software-defined data center (SDDC) with hyperconverged infrastructure (HCI). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in data center 112 deployment. For example, data center 112 may include different components such as a server virtualization application 124 (e.g., vSphere of VMware®), a storage virtualization application 126 (e.g., vSAN of VMware®), a network virtualization and security application 128 (e.g., NSX of VMware®), physical host computing systems 130 (e.g., ESXi servers), or any combination thereof.

Further, data center 112 may include a cloud management and automation platform 122 to deploy different components and manage different workloads such as virtual machines 114, containers 116, virtual routers 118, applications 120, and the like. Virtual machines 114, in some embodiments, may operate with their own guest operating systems on a physical computing device using resources of the physical computing device virtualized by virtualization software (e.g., a hypervisor, a virtual machine monitor, and the like). Containers 116 are data computer nodes that run on top of the host operating systems without the need for a hypervisor or separate operating system. In some examples, data center 112 may include one or more workload domains, each workload domain representing a logical unit that groups physical computing devices managed by management node 102 (e.g., vCenter server) with specific characteristics according to SDDC polices.

An example platform to deploy and manage data center 112 may include VMware Cloud Foundation™ (VCF), which is commercially available from VMware. VCF may be a hybrid cloud platform that provides a full stack hyperconverged infrastructure that is made for modernizing data centers and deploying modern container-based applications. VCF integrates different components like vSphere (compute), vSAN (storage), NSX (networking), and some parts of the vRealize Suite in a hyper-converged infrastructure solution with infrastructure automation and software lifecycle management. The idea of VCF follows a standardized, automated, and validated approach that simplifies the management of the needed software-defined infrastructure resources. So, VCF is fully integrated software composed of vSphere, NSX, vSAN, and SDDC manager based on the concepts of HCI, which accelerates the delivery of virtual infrastructure (VI) or virtual desktop infrastructure (VDI).

Data center operations refer to the workflow and processes that are performed within data center 112 to keep data center 112 running. The data center operations include computing and non-computing processes that are specific to a data center facility or data center environment. The data center operations include automated and manual processes essential to keep the data center operational. For example, the data center operations include installing and maintaining network resources, ensuring data center security and monitoring systems that take care of power and cooling.

As shown in FIG. 1A, data center 112 may be communicatively connected to management node 102 via a network 134. Example network 134 can be a managed Internet protocol (IP) network administered by a service provider. For example, network 134 may be implemented using wireless protocols and technologies, such as Wi-Fi, WiMAX, and the like. In other examples, network 134 can also be a packet-switched network such as a local area network, wide area network, metropolitan area network, Internet network, or other similar type of network environment. In yet other examples, network 134 may be a fixed wireless network, a wireless local area network (LAN), a wireless wide area network (WAN), a personal area network (PAN), a virtual private network (VPN), intranet or other suitable network system and includes equipment for receiving and transmitting signals.

Management node 102 may include a processor 104. Processor 104 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein. Further, management node 102 includes memory 106 coupled to processor 104. Memory 106 includes a risk assessment unit 108. Furthermore, management node 102 may include message bus 110. In some examples, messages/data may be published to message bus 110. Further, a consumer service 132 may receive the messages/data from message bus 110 based on subscriptions.

During operation, risk assessment unit 108 may configure a risk entity. The risk entity may be a logical construct configured by a user based on user's experience or needs of working with the resource. The risk entity may include a risk type and a risk level corresponding to the risk type. For example, risk assessment unit 108 may receive, via a graphical user interface, a selection of risk parameter information on a template for inclusion in the risk entity. The risk parameter information may include the risk type and the risk level corresponding to the risk type. The template may include predefined fields for receiving a risk name, the risk type, the risk level, and the like. In an example, risk assessment unit 108 may configure the risk entity based on the received risk parameter information (e.g., a user-driven risk). In another example, risk assessment unit 108 may configure the risk entity using a plugin (e.g., a system-driven risk) that includes risk parameter information (e.g., the risk type and the risk level corresponding to the risk type) to configure the risk entity.

Further, risk assessment unit 108 associate the risk entity to the resource deployed in data center 112. In an example, the resource may include a compute node (physical or virtual) such as physical host computing system 130, virtual machine 114, container 116, virtual router 118, and the like. In another example, the resource includes a workload domain including plurality of compute nodes executing plurality of applications app 1-app N in data center 112. Upon associating the risk entity to the resource, risk assessment unit 108 may monitor the resource to assess a risk value associated with the resource based on the risk type and the risk level. For example, risk assessment unit 108 may monitor a first compute node of plurality of compute nodes to assess the risk value of the first compute node. Further, risk assessment unit 108 may generate a risk assessment report corresponding to the monitored resource.

Furthermore, risk assessment unit 108 may publish the risk assessment report on message bus 110. Further, message bus 110 may send the risk assessment report to subscribed consumer service 132. For example, message bus 110 may send the risk assessment report to a graphical user interface of subscribed consumer service 132 via an application programming interface (API). Thus, message bus 110 may act as a messaging queue for a risk and consumer service 132.

In another example, risk assessment unit 108 may prevent an operation from being performed corresponding to the resource based on the risk value. For example, risk assessment unit 108 may monitor the resource to assess a risk of failure of the operation to be performed corresponding to the resource. The operation may be associated with the risk type. Further, risk assessment unit 108 may prevent the operation from being performed when the risk of failure of the operation to be performed is greater than a threshold. Thus, the operation may be processed or cancelled based on the risk value.

FIG. 1B is a block diagram of example computing environment 100 of FIG. 1A, depicting additional features. Similarly named elements of FIG. 1B may be similar in function and/or structure to elements described in FIG. 1A. As shown in FIG. 1B, risk assessment unit 108 may include a risk manager 152, a risk operator 158, and a risk analysis engine 156. Risk manager 152 may enable to create a user-driven risk 154A and/or a system-driven risk 154B. In an example, risk manager 152 may enable a user to configure user-driven risk 154A. In another example, risk manager 152 may enable a plugin (e.g., a custom workflow risk plugin 160A that communicates with an operation risk analyzer plugin 160B) to configure system-driven risk 154B.

Further, risk operator 158 may be responsible for discovering the risks configured by the user or the system. Based on the resources that are attached to the risks, risk operator 158 orchestrates risk analysis engine 156 to continuously monitor the resource and generate a report. Risk analysis engine 156 may be responsible for analyzing the details of risk (i.e., assess a risk value of the resource) and attached resource and operationalises the monitoring of the resource. Further, risk analysis engine 156 may publish the details to message bus 110 when particular risk is met so that consumer services 132 (e.g., SDDC manager services such as an operations manager 162, a lifecycle manager 164, a domain manager 166, and the like) can be notified to take necessary actions. In this example, message bus 110 works as a messaging queue for the risk and consumer services 132.

Thus, examples described herein may provide risk assessment unit 108 to configure a set of pre-canned risk entities which tracks a set of configurations and raise alarms based on the configuration. Further, based on the workflow to be performed, the user can attach relevant risk entities to analyze the system state and decide to perform the operation or not. Also, with the examples described herein, the risk analysis may be executed as a mock operation on the system without impacting a production environment. Also, the users can create their own risks based on prior experience (e.g., previous failures and learning) and set desired values for the risk configurations.

In some examples, the functionalities described in FIGS. 1A and 1B, in relation to instructions to implement functions of risk assessment unit 108 and any additional instructions described herein in relation to the storage medium, may be implemented as engines or modules including any combination of hardware and programming to implement the functionalities of the modules or engines described herein. The functions of risk assessment unit 108 may also be implemented by a processor. In examples described herein, the processor may include, for example, one processor or multiple processors included in a single device or distributed across multiple devices.

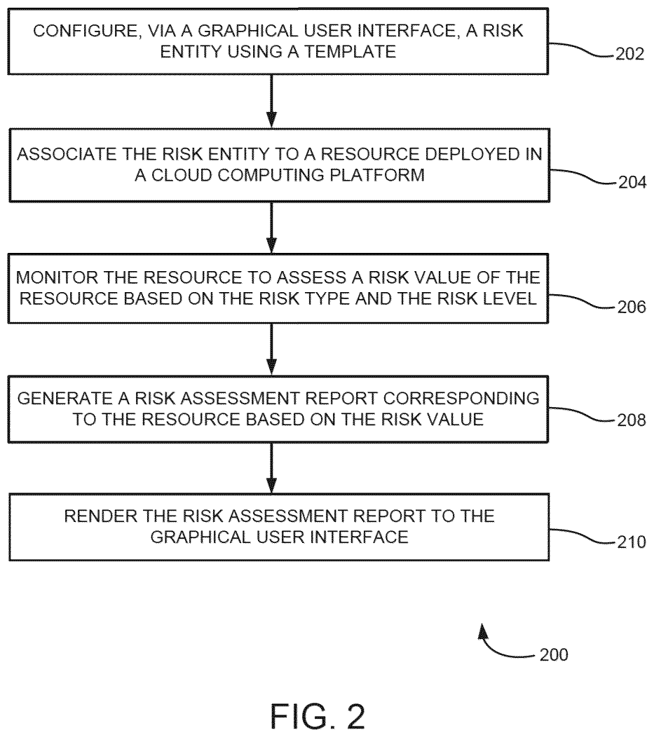

FIG. 2 is a flow diagram illustrating an example computer-implemented method 200 for generating a risk assessment report corresponding to a resource in a computing environment based on a configured risk entity. Example method 200 depicted in FIG. 2 represent generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow chart illustrates functional information to design/fabricate circuits, generate computer-readable instructions, or use a combination of hardware and computer-readable instructions to perform the illustrated processes.

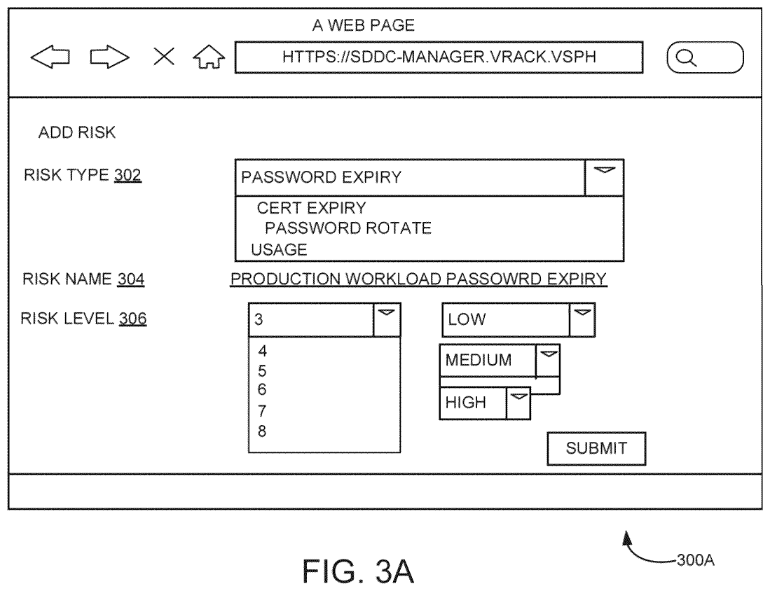

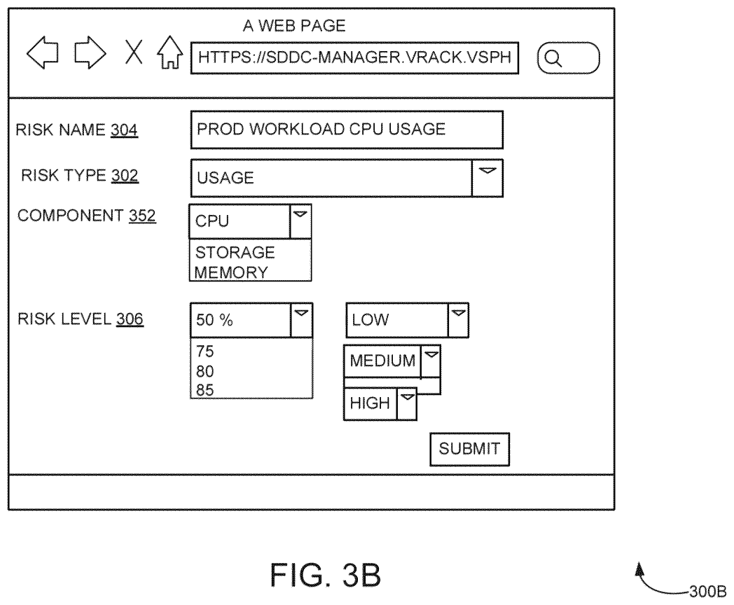

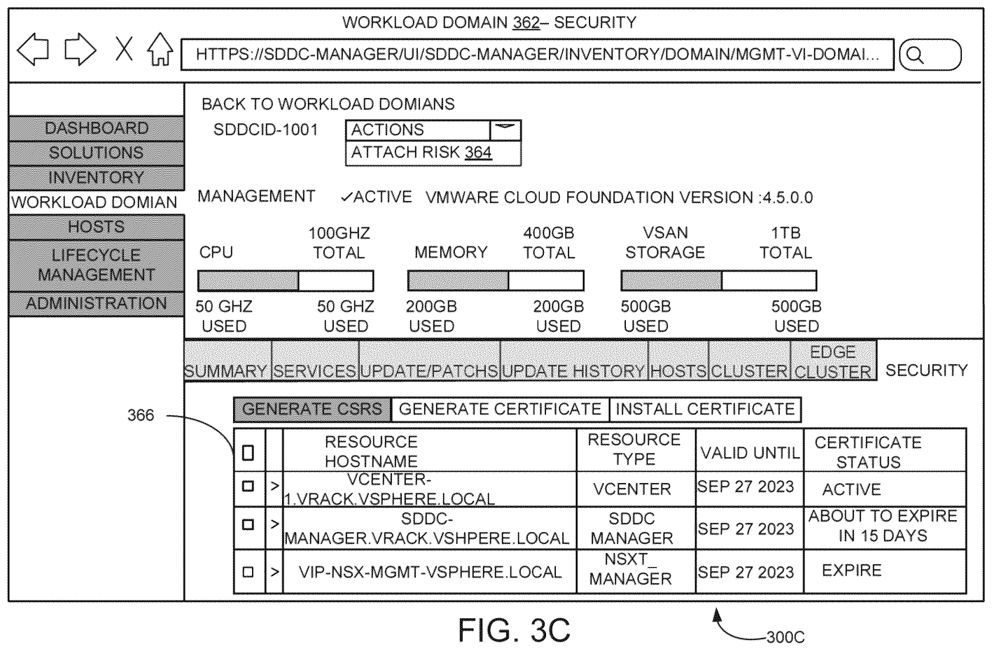

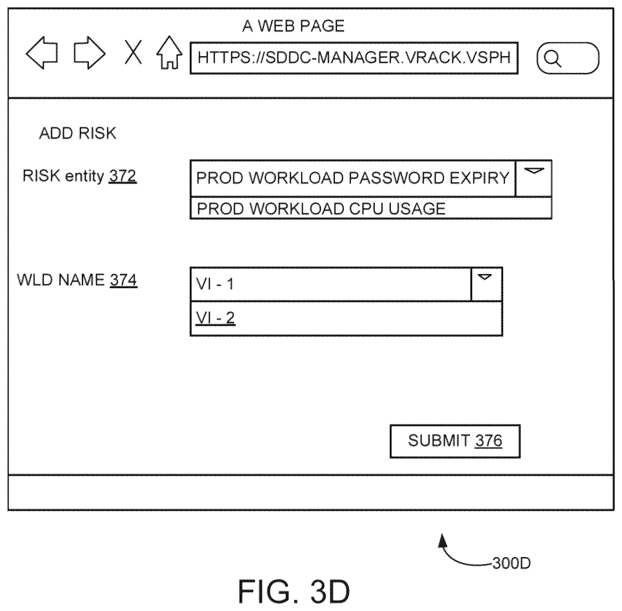

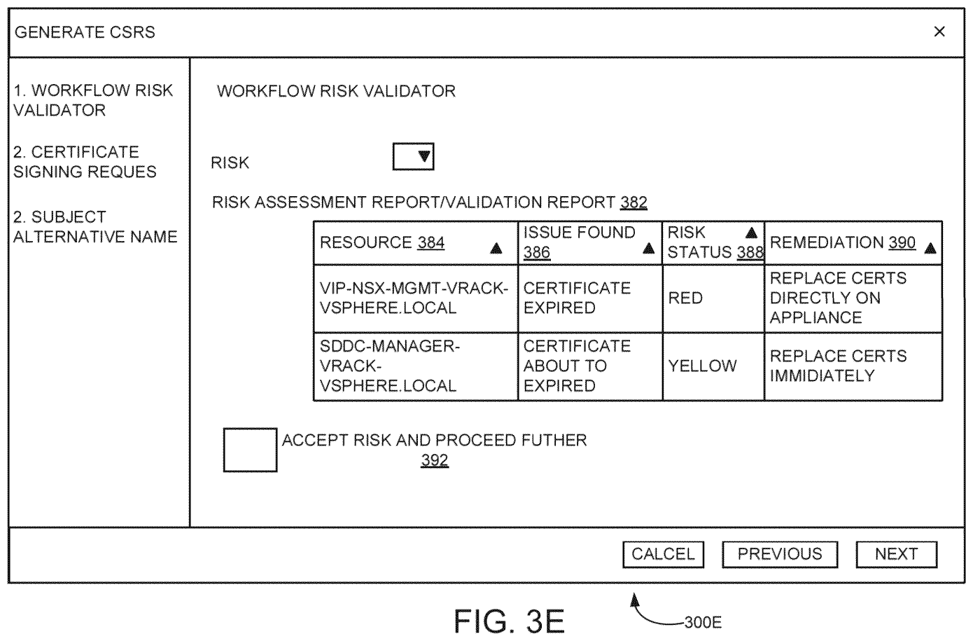

At 202, a risk entity may be configured, via a graphical user interface, using a template. The risk entity may include a risk type and a risk level corresponding to the risk type. In an example, configuring the risk entity using the template may include selecting, via the graphical user interface, risk parameter information on the template for inclusion in the risk entity. For example, the risk parameter information may include the risk type and the risk level corresponding to the risk type. An example graphical user interface to configure the risk entity is described in FIGS. 3A and 3B.

At 204, the risk entity may be associated to a resource deployed in a cloud computing platform. The resource may include a workload domain including a plurality of compute nodes executing a plurality of applications. An example graphical user interface to associate the risk entity to the resource is described in FIGS. 3C and 3D. At 206, the resource may be monitored to assess a risk value of the resource based on the risk type and the risk level. In an example, monitoring the resource may include monitoring a compute node of the plurality of compute nodes to assess the risk value of the compute node. In this example, monitoring the resource may include monitoring the resource to assess a risk of failure of the operation to be performed on the resource. The operation may be associated with the risk type. For example, the operation may include a password management operation (e.g., password rotation operation), a certificate management operation, data center management operation, and the like to be performed on the resource. Example risk type may include password expiry, computing resource usage (e.g., processor usage, memory usage, and the like), and the like associated with the resource.

At 208, a risk assessment report corresponding to the resource may be generated based on the risk value. In an example, generating the risk assessment report may include generating the risk assessment report including a current system state of the resource corresponding to the risk type. The system state may refer to any aspect of the hardware, operating system, or application program state of the monitored resource. The system state may include information associated with the resource related to running applications, processing jobs, CPU utilization, storage information, and the like. For example, the system state may include background processes that are currently running, application programs that are currently running, operating states of running application programs, whether an application program or process is the foreground application or process, whether a deployment lock is being held, and the like.

At 210, the risk assessment report may be rendered to the graphical user interface. Further, the risk assessment report may be published on a message bus. In an example, the message bus may send the risk assessment report to a graphical user interface of a management application or a subscribed consumer service via a network.

Consider an example “adaptive password rotation” operation. In this example, as part of the risk entity configuration, the risk level may be set to low, medium, or high. For example, the risk level “low” indicates that the “adaptive password rotation” operation may be executed if the risk is low. Further, the risk level “medium” indicates that the “adaptive password rotation” operation may be executed if the risk is medium. Furthermore, the risk level “high” indicates that the “adaptive password rotation” operation may be executed as per the schedule.

Further, based on ongoing password operations and number of failures, a risk value may be dynamically calculated and set. For example, VMware Cloud Foundation (VCF) user interface (UI) may not be regularly visited by the user. In such cases, when any failed run holds a lock and is not cancelled by the user explicitly, all the following scheduled runs inadvertently do not execute. Holding the locks can set the risk level to high and abandon all the auto-rotate schedules until locks are released. Further, continuous failures can escalate the risk and hence prevent the auto-rotate of passwords for the resources on which the risk level is set to low. The risk assessment can be further improved based on the resource types, failure types, and the like. Further, once failures are fixed, post troubleshooting the user can manually set the risk value to low on the system. Furthermore, a Customer Experience Improvement Program (CEIP)-based risk learning engine pro-actively avoid failures of the operations and keep the system in a consistent state, for instance. Hence, the user may get control over which resource can/cannot execute the rotation operations based on the current system consistency level.

Consider another example “adaptive upgrades” operation. In this example, as part of the risk entity configuration, the risk level may be set to low, medium, or high. For example, the risk level “low” indicates that the “adaptive upgrades” operation may be executed if the risk is low. Further, the risk level “medium” indicates that the “adaptive upgrades” operation may be executed if the risk is medium. Furthermore, the risk level “high” indicates that the “adaptive upgrades” operation may be executed on schedule.

Further, the resource may be monitored to assess a risk value associated with the resource based on the configured risk entity. In this example, the risk value may be assessed by assigning each pre-check a risk level. When a specific pre-check fails, it sets the risk level of the overall upgrade state. Further, the risks at each of the pre-checks may be aggregated based on the priority level and the highest priority is taken to set upgrade risk level (e.g., the risk value). Post troubleshooting, once the failures are fixed, the user can manually set the risk value to low on the system. Also, compatibility of dependent versions can be examined to assess the risk value.

FIG. 3A is an example graphical user interface 300A depicting creation of a risk entity. In an example, the risk entity may be created on a software defined data center manager (e.g., a management component that provides a centralized management plane for the provisioning, monitoring and ongoing management of both the logical and physical resources that make up the VCF-based private cloud). Further, the risk entity may be created by configuring a risk type 302, a risk name 304, and a risk level 306. In example graphical user interface 300A, the risk entity is created with risk name 304 as “product workload password expiry”, risk type 302 as “password expiry”, and risk level 306 as “low”, “high”, “medium” or any numerical value. In an example, configuring the risk type may bring relevant analysis into each risk entity based on the association.

FIG. 3B is another example graphical user interface 300B depicting creation of another risk entity for a component 352 in a data center. In example graphical user interface 300B, the risk entity is created by configuring risk name 304 as “product workload CPU usage”, risk type 302 as “usage” for component 352 (e.g., a central processing unit (CPU)), and risk level 306 as “low”, “high”, “medium”, or as a percentage of total capacity.

FIG. 3C is an example graphical user interface 300C depicting attaching the risk entity of FIG. 3A to a resource. In an example, the risk entity (e.g., “product workload password expiry” of FIG. 3A) can be associated to the resource (e.g., a workload domain). Upon attaching the risk entity, the resource may be constantly monitored based on the entity type. For example, when the risk entity (e.g., product workload password expiry) is associated to the resource, password expiry dates of the resource (e.g., a workload domain) and the sub-resources (e.g., compute nodes of the workload domain) corresponding to the resource may be constantly monitored. In example graphical user interface 300C, an option (e.g., 364) to attach/associate the risk entity to the resource (e.g., a workload domain 362 “security”) is provided. Also, graphical user interface 300C depicts a report 366 including a risk status of monitored resources.

FIG. 3D is another example graphical user interface 300D depicting attaching the risk entity of FIGS. 3A and 3B to a resource. In example graphical user interface 300D, the configured risk entity “product workload password expiry” of FIG. 3A is attached to workload domain “VI-1” and the configured risk entity “product workload CPU usage” of FIG. 3B is attached to workload domain “VI-2”. In this example, the configured risks may be selected using an option 372 (e.g., a drop-down menu) and the workload domains may be selected using an option 374 (e.g., a drop-down menu). Further, upon selecting the risk entity and the resource, an option 376 may be provided to attach the risk entity to the resource.

FIG. 3E is an example graphical user interface 300E depicting a risk assessment report 382. In an example, upon attaching a risk entity to a resource as described in FIGS. 3C and 3D, continuous evaluation or monitoring of the resource may begin and corresponding risk assessment report 382 may be generated. Further, risk assessment report 382 may provide details such as resources being affected (e.g., 384), issues found (e.g., 386), corresponding risk statuses (e.g., 388), remediations (e.g., 390), and the like as shown in FIG. 3E. Further, example graphical user interface 300E may provide an option (e.g., 392) for a user to accept the risk and to proceed further without any action, i.e., to perform the operation based on the user-discretion.

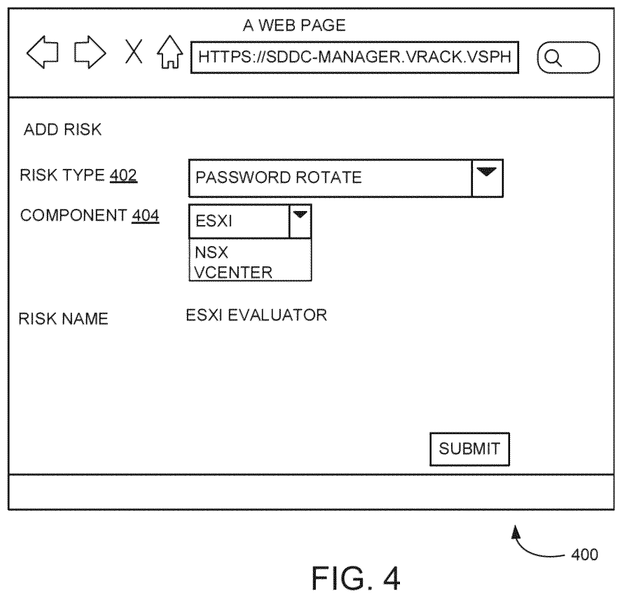

FIG. 4 is an example graphical user interface 400 depicting associating a risk type (e.g., 402) to an operation associated with a resource (e.g., component 404). In an example, risk type 402 can be directly associated to a scheduled operation (e.g., a password auto-rotate operation). The password auto-rotate operation is an operation that can be scheduled to run every 15 days or at a specific interval of user's choice. In such a scenario, predicting state of the resource over a period may be challenging. The password auto-rotate operation may fail if a deployment lock is held by some other operation which is in progress. Further, execution of the auto rotate operation during this stage may result in a failure. Below example steps may be followed to avoid the failure.
A risk entity named “ESXi evaluator” can be created and the risk entity can be configured to report high risk when the deployment lock is being held.
The risk entity can be associated to risk type 402 “password auto-rotate operation” for component 404 “ESXi”.
When the scheduled rotation happens when the deployment lock is held, the risk entity may report high risk because of the association. Further, the user can pre-configure this schedule to setup whether to run the auto-rotate operation based on user discretion, thereby avoiding unnecessary failures on the scheduled operations.

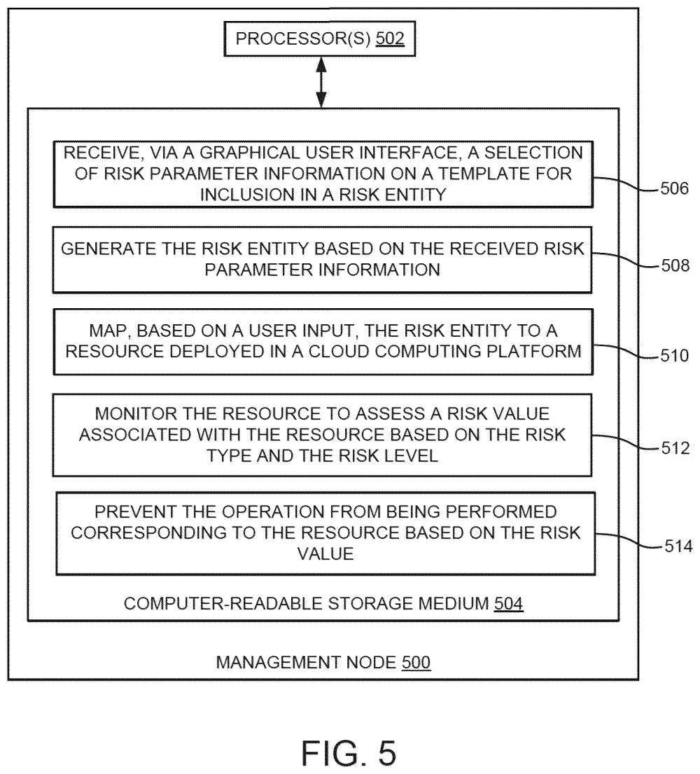

FIG. 5 is a block diagram of an example management node 500 including non-transitory computer-readable storage medium 504 storing instructions to prevent an operation from being performed corresponding to a resource in a computing environment based on a configured risk entity. Management node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to management node 500.

Computer-readable storage medium 504 may store instructions 506, 508, 510, 512, and 514. Instructions 506 may be executed by processor 502 to receive, via a graphical user interface, a selection of risk parameter information on a template for inclusion in a risk entity. In an example, the risk parameter information includes a risk type corresponding to an operation and a risk level corresponding to the risk type

Instructions 508 may be executed by processor 502 to generate the risk entity based on the received risk parameter information. Instructions 510 may be executed by processor 502 to map, based on a user input, the risk entity to a resource deployed in a cloud computing platform.

Instructions 512 may be executed by processor 502 to monitor the resource to assess a risk value associated with the resource based on the risk type and the risk level. In an example, instructions 512 to monitor the resource may include instructions to:
monitor runtime behavior events associated with the resource,
assign, based on the monitoring the runtime behavior events, a respective risk score to each of the runtime behavior events that results in a failure of the operation, each risk score indicating a failed operation, and
determine the risk value of the resource based on aggregating the respective risk scores.

In an example, instructions 512 to monitor the resource may include instructions to monitor the resource to assess a risk of failure of the operation to be performed on the resource. The operation may be associated with the risk type.

Instructions 514 may be executed by processor 502 to prevent the operation from being performed corresponding to the resource based on the risk value. In an example, instructions 514 to prevent the operation from being performed may include instructions to prevent the operation from being performed corresponding to the resource based on the aggregated risk scores.

Further, computer-readable storage medium 504 may store instructions to generate a risk assessment report corresponding to the monitored resource upon preventing the operation from being performed. Further, the instructions may be stored to render the risk assessment report to the graphical user interface and permit the operation corresponding to the resource in response to receiving a user input via the graphical user interface.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A management node comprising:
a processor; and
memory coupled to the processor, wherein the memory comprises:
a message bus; and
a risk assessment unit to:
configure a risk entity, the risk entity comprising a risk type and a risk level corresponding to the risk type;
associate the risk entity to a resource deployed in a cloud computing platform;
monitor the resource to assess a risk value associated with the resource based on the risk type and the risk level;
generate a risk assessment report corresponding to the monitored resource; and
publish the risk assessment report on the message bus, wherein the message bus is to send the risk assessment report to a subscribed consumer service.

2. The management node of claim 1, wherein the risk assessment unit is to:
prevent an operation from being performed corresponding to the resource based on the risk value.

3. The management node of claim 2, wherein the risk assessment unit is to:
monitor the resource to assess a risk of failure of the operation to be performed corresponding to the resource, wherein the operation is associated with the risk type; and
prevent the operation from being performed when the risk of failure of the operation to be performed is greater than a threshold.

4. The management node of claim 1, wherein the risk assessment unit is to:
receive, via a graphical user interface, a selection of risk parameter information on a template for inclusion in the risk entity, the risk parameter information comprising the risk type and the risk level corresponding to the risk type; and
configure the risk entity based on the received risk parameter information.

5. The management node of claim 1, wherein the risk assessment unit is to:
configure the risk entity using a plugin that includes risk parameter information to configure the risk entity, the risk parameter information comprising the risk type and the risk level corresponding to the risk type.

6. The management node of claim 1, wherein the resource comprises a workload domain including a plurality of compute nodes executing a plurality of applications.

7. The management node of claim 6, wherein the risk assessment unit is to:
monitor a first compute node of the plurality of compute nodes to assess the risk value of the first compute node.

8. The management node of claim 1, wherein the message bus is to:
send the risk assessment report to a graphical user interface of the subscribed consumer service via an application programming interface (API).

9. A method comprising:
configuring, via a graphical user interface, a risk entity using a template, the risk entity comprising a risk type and a risk level corresponding to the risk type;
associating the risk entity to a resource deployed in a cloud computing platform;
monitoring the resource to assess a risk value of the resource based on the risk type and the risk level;
generating a risk assessment report corresponding to the resource based on the risk value; and
rendering the risk assessment report to the graphical user interface.

10. The method of claim 9, further comprising:
publishing the risk assessment report on a message bus, wherein the message bus is to send the risk assessment report to a graphical user interface of a management application or a subscribed consumer service via a network.

11. The method of claim 9, wherein the resource comprises a workload domain including a plurality of compute nodes executing a plurality of applications.

12. The method of claim 11, wherein monitoring the resource comprises:
monitoring a compute node of the plurality of compute nodes to assess the risk value of the compute node.

13. The method of claim 9, wherein configuring the risk entity using the template comprises:
selecting, via the graphical user interface, risk parameter information on the template for inclusion in the risk entity, the risk parameter information comprising the risk type and the risk level corresponding to the risk type.

14. The method of claim 9, wherein monitoring the resource comprises:
monitoring the resource to assess a risk of failure of the operation to be performed on the resource, wherein the operation is associated with the risk type.

15. The method of claim 9, wherein generating the risk assessment report comprises:
generating the risk assessment report including a current system state of the resource corresponding to the risk type.

16. A non-transitory computer-readable storage medium encoded with instructions that, when executed by a processor of a management node, cause the processor to:
receive, via a graphical user interface, a selection of risk parameter information on a template for inclusion in a risk entity, the risk parameter information comprising a risk type corresponding to an operation and a risk level corresponding to the risk type;
generate the risk entity based on the received risk parameter information;
map, based on a user input, the risk entity to a resource deployed in a cloud computing platform;
monitor the resource to assess a risk value associated with the resource based on the risk type and the risk level; and
prevent the operation from being performed corresponding to the resource based on the risk value.

17. The non-transitory computer-readable storage medium of claim 16, wherein instructions to monitor the resource comprise instructions to:
monitor runtime behavior events associated with the resource;
assign, based on the monitoring the runtime behavior events, a respective risk score to each of the runtime behavior events that results in a failure of the operation, each risk score indicating a failed operation; and
determine the risk value of the resource based on aggregating the respective risk scores.

18. The non-transitory computer-readable storage medium of claim 17, wherein instructions to prevent the operation from being performed comprise instructions to:
prevent the operation from being performed corresponding to the resource based on the aggregated risk scores.

19. The non-transitory computer-readable storage medium of claim 16, further comprising instructions to:
upon preventing the operation from being performed, generate a risk assessment report corresponding to the monitored resource;
render the risk assessment report to the graphical user interface; and
permit the operation corresponding to the resource in response to receiving a user input via the graphical user interface.

20. The non-transitory computer-readable storage medium of claim 16, wherein instructions to monitor the resource comprise instructions to:
monitor the resource to assess a risk of failure of the operation to be performed on the resource, wherein the operation is associated with the risk type.
